(19) United States
(12) Patent Application Publication
(10) Pub. No.: US 2025/0312233 A1
(43) Pub. Date: Oct. 9, 2025

(54) Triple Action Massage Gun

(71) Applicant: Charles Curley, Cortland, NY (US)

(72) Inventor: Charles Curley, Cortland, NY (US)

(21) Appl. No.: 19/243,926

(22) Filed: Jun. 20, 2025

Related U.S. Application Data
(63) Continuation-in-part of application No. 17/489,014, filed on Sep. 29, 2021, now Pat. No. 12,357,530.

(51) Int. Cl. A61H 23/00; A61H 15/00; A61H 23/02

(52) U.S. Cl. CPC A61H 23/006; A61H 15/0085; A61H 23/0254; A61H 2015/0021; A61H 2201/0153; A61H 2201/0157; A61H 2201/1215; A61H 2201/1436; A61H 2201/1669; A61H 2201/1678; A61H 2201/1695

(57) ABSTRACT

A handheld motorized massage gun combines the percussive action of conventional percussive-type massage guns with muscle stretching action and kneading action of rolling element massage devices. The self-powered, self-standing instrument orbits a single massage head along a reciprocating circular arc which induces percussive forces perpendicular to the fascia, induces stretching forces along the elongate axis of the fascia and also produces skin rolling action upon adipose fascia. The self-standing suspension allows the device to be stably focused upon a specific fascia region with one hand for the purpose of treating cellulite and/or providing muscle rehabilitation. Among various features, the instrument has a handle portion suitable for operating with one hand, a single massage head for oscillating upon the surface of a fascia, and a non-oscillating gripping surface for anchoring the massage gun upon a fascia surface.

### BACKGROUND OF THE INVENTION

There exist many massage therapies and massage devices which have been designed to rehabilitate muscle fiber or treat cellulite by rubbing, twisting, beating, stretching, compressing and rolling the upper superficial fatty layer and muscle layers that reside immediately underneath the skin. Three of the most common massage techniques used by massage therapists are called 1) Myofascial Release, 2) Petrissage and 3) Tapotement (percussive massage). While these are techniques utilized by massage therapists, mechanized devices have been developed to simulate each of these techniques, thus alleviating the tiring manual tasks utilized by human massage therapists.

One simple type of massage therapy device simulates a technique called myofascial release, which is a form of soft tissue therapy intended to increase blood circulation, decompose fat cells, stretch muscles and relieve pain. Tightened muscle and tissue fibers are called “myofascial restrictions”. Myofascial release therapy stretches and compresses the fascia to alleviate the restrictions, decompose fat cells and make the tissue fiber more flexible. FIG. 1 illustrates the reciprocating motion of the therapist's hands while performing this type of massage. The fascial region between the two hands is compressed as the hands move together, and then stretched as the hands move apart, such that the massage-receiving region is cyclically compressed and stretched to relieve the restrictions.

Massage devices that simulate the Myofascial Release technique typically utilize balls or rollers that are traversed over the fascia regions to release the restrictions. FIG. 2 is reproduced from prior art U.S. Pat. No. 7,169,120 and illustrates a very simple massage device that utilizes a revolving ball to simulate myofascial release massage. This is called a “passive” massage device because the reciprocating motion is provided by the user, who grasps the device 1090 by handle 1098 and drags the device along the massage-receiving surface with a reciprocating motion. As shown in FIG. 3, the ball 1096 produces a traveling compressive wave along the fascia in front of its path as it is pushed along the surface by the user. The rotation of the ball allows the wave to be created without uncomfortable frictional drag along the fascia surface. The compressive wave region of the fascia is compressed, while the region of fascia that trails the ball is stretched. As the user reciprocates the ball along the massage-receiving surface, the fascial regions surrounding the ball experience alternating modes of compression and stretching as the traversing direction is changed.

Another myofascial massage device is taught by prior art U.S. Pat. No. 3,970,078 to inventor Charles Rogers, which is also a passive (non-motorized) massage device which utilizes multiple rollers. FIG. 4 is an illustration of the Rogers '078 device as reproduced from that disclosure and explains two pairs of rollers having pyramidal surface protrusions that rotate upon axles as a user traverses the device along a targeted fascia. The user's reciprocating motion alternately compresses and stretches the fascia region between the two pairs of rollers, producing myofascial massage along the adipose fascia. The disclosure's author also claims that the device is advantageous in treating cellulite, explaining;
The handle is of a convenient size to be grasped by one hand to roll the massage rollers over fleshy and fat or “cellulite” areas of a human body to knead and manipulate the flesh and fat and thus break down the gel-like lumps of cellulite and dissipate them through normal body circulatory functions. In addition, it massages, tones and strengthens the body as it is rolled thereover, and is also used for this function alone. (U.S. Pat. No. 3,970,078 Abstract)

A second massage technique that is said to relax muscles and treat cellulite is called Tapotement, which is merely the rapid and repeated striking of the fascia. This technique is commonly known as “percussive massage” in laymen's terms. Tapotement massage techniques are techniques that are used by therapists upon body fascia that involve percussion movements, such as tapping, thumping, pounding, cupping and similar strikes. FIG. 5 illustrates the hand movement of a massage therapist when performing one exemplary type of percussive massage. In this illustration, the fingers are extended. In other percussive massage variations, the fingers are folded inward to form a fist.

Mechanical devices that simulate percussive massage are commonly called “massage guns” or “fascia guns”. These devices use a reciprocating piston to impart percussive forces against a target area of the fascia and are said to be effective for treatment of the deeper fascia and muscle tissue. Many such devices have been patented and commercialized, and some have been marketed as “Anti-Cellulite Massagers”. An example of a battery powered percussive massage gun configuration is shown in the illustration of FIG. 6 which is similar to the configurations described in a myriad of prior art design patents and utility patents.

Referring to FIG. 6, a massage gun 900 has a percussive massage head 905 with a spherical shape which is mounted on the end of a piston 906 that reciprocates in the direction of the axis of the arrow 904 within the housing 902 to create a straight-line reciprocating movement of the head 905. The main housing 901 has a cylindrical extension 903 which houses a battery-driven motor. As exemplified in many prior art devices, the cylindrical battery assembly 918 has the dual functions of housing the battery and also acting as the handle for the massage gun 900. The user grips the cylindrical extension 918 in a way similar to grasping a pistol and then presses the massage head 905 against the target muscle or tissue of the human body. The reciprocating head motion is initiated by engaging an “ON” switch. This type of massage device produces only straight-line reciprocating motion of the massage head 905 perpendicular to the fascia surface. Additionally, the person holding these devices experiences a “reactionary bounce” which causes difficulty in holding the device steady over a chosen muscle target.

The effectiveness of the massage gun depends upon the user's ability to hold the gun steady while applying pressure to the target fascia location. The percussive action of the reciprocating head causes an equal and opposite reaction at the user's hand, causing the body of the massage gun to jump around. The instability makes it difficult to hold the gun focused upon the target location, especially at low piston reciprocating speeds. The reaction on the user also causes fatigue when attempting to focus the gun on a specific location for a sustained period of time.

One solution for improving stability of the massage head over the muscle target is to use two hands to steady the massage gun as described in U.S. Pat. No. 10,959,908 B2 to inventor Steven Lee et al. (referred to as Lee '908). Lee '908 discloses an ergonomically improved massage gun that uses two handles that are arranged in the shape of a Y as shown in prior art FIG. 7. Prior art FIG. 8 is an excerpt from Lee '908 which shows the Y shaped massage gun being used on a person's thigh. Lee '908 explains that;
The two handles allows the therapist to apply the massage with significant force, and the relatively large distance between the locations where the therapist is gripping the device allow for significant stability so that the massager 10 does not easily slip away from its intended position and the targeted spot on the patient's body. (Lee '098 7:65-66, 8:1-4)
The user can comfortably hold the percussive massage appliance 10 with both hands while delivering to himself a percussive massage via reciprocating action of the percussive massage head. (Lee '098 7:43-46)

Another means for relieving the massage gun stabilization problem is the utilization of a “focusing rest” as taught by copending patent application US 2022/0354735 A1. FIG. 9 illustrates one embodiment from that disclosure which teaches an attachment 220 having an elastomeric focusing rest 223 which is used to anchor the massage gun in a steadied position upon the fascia surface while focusing treatment upon a specific muscle. The term “focusing rest” was explained in copending patent application US 2022/0354735A1 where the term describes an appendage that allows the massage gun to be stabilized by resting a non-oscillating surface upon the fascia while focusing the reciprocating portion upon a particular muscle or fascia region. FIG. 10 illustrates how contact of the non-oscillating surface with the fascia surface aids the user in anchoring the massage device in a fixed position and acts as a fulcrum for applying variable force at the massage head.

Referring to FIG. 9, a percussive massage gun 227 has a handle 221 for operating the device with one hand while putting downward force on the handle. The force is partially divided in response between oscillating massage head 224 and the non-oscillating contact surface of focusing rest 223 while the massage head reciprocates in a direction 229 that is perpendicular to the fascia surface. The massage gun 227 is incapable of providing massage forces parallel to the fascia surface as required for myofascial release (see FIG. 1).

Most of the prior art massage patent disclosures utilize the terminology “massage head” to describe that object which oscillates against the fascia surface. That term is prevalent in the prior art to globally describe many shapes which are utilized by massage guns to impinge upon the fascia surface including cones, balls, rollers, cups, fingers, blades and cylinders. For purposes of the explanation herein, the term massage head and massage roller are used interchangeably.

Petrissage is a third type of massage technique used for the treatment of cellulite, and is sometimes called the palpate-roll technique. This technique utilizes repetitious skin rolling and kneading. Skin rolling is a technique whereby the therapist pinches the fascia and rolls the pinched region along the surface. Kneading is the process of repetitiously pinching and then releasing the skin fold. FIG. 11 demonstrates the hand motion of a therapist utilizing Petrissage to create a skin fold.

The handheld device in FIG. 3 demonstrates the compressed rolling fascia bulge that is created by rolling compression during skin rolling. The compressed fascia bulge in the fleshy fascia in front of the roller 1096 is called a “skin roll” because it rolls along the fascia surface in wave-like manner in front of the roller. The fascia is compressed in front of the roller and thereafter stretched in the region behind the roller. The action of creating a skin roll and then stretching it is said to be effective in treating cellulite. A wide array of handheld roller configurations called “cellulite rollers” are marketed for this purpose. The device illustrated in FIG. 4 is an example of a simple anti-cellulite device.

There exist many patents of mechanized devices that simulate petrissage (skin rolling) techniques, and many of them use vacuum to create the skin fold by raising a small section of fascia above the surrounding fascia surface. Prior art U.S. Pat. No. 5,665,053 teaches a vacuum device which utilizes a vacuum pump and two rollers to perform Petrissage massage. FIG. 12 is reproduced from that patent and illustrates the effect of the vacuum 1325 in creating a skin fold. This is a passive device 1310 that is dragged along the massage-receiving surface by the user as the vacuum source is applied to the chamber 1324. As the skin fold is raised by the vacuum, the two rollers 1326A and 1326B are mounted in slots which allow the vacuum to pull them closer together, thus assisting in holding the skin fold in the elevated position. The two rollers 1323 and 1327 roll in the same direction as the user moves the device in the direction shown. This patent explains that the skin fold consists of four layers including the skin 1312, the superficial fatty layer 1314, the fascia superficialous 1316, and the deep fatty layer 1318. The device is incapable of producing the reciprocating compression and stretching cycle that is induced by the myofascial release technique. Nor can the device produce percussive massage forces.

Another massage device that utilizes the Petrissage method is taught by prior art U.S. Pat. No. 4,729,368 (the '368 patent). FIG. 13 is reproduced from that disclosure and illustrates a handheld device 1400 that is attached to a vacuum pump which provides suction in the direction indicated by the arrow via an umbilical tube 1421. The suction creates a skin fold in the region between the two rollers 1403 and 1404. The disclosure explains;
The vacuum produced inside the chamber 24 provokes suction and pinching of the skin and tends automatically to move the two rollers 3, 4 towards each other to exert a pressure on the skin imprisoned therebetween. It is therefore possible to pinch more or less firmly, as a function of the value of the vacuum created in the chamber. ('368 5:49-55)

The device rollers 1403 and 1404 may also be powered by a motor to propel the device along the fascia surface. A switch on the handle 1402 of the device 1400 allows the operator to reverse the direction along which the device is propelled by rollers 1403 and 1404. This device is incapable of applying percussive massage or applying alternating stretching and compression of the fascia surface.

Another Petrissage device which cyclically pinches and collapses skin folds (kneading) is explained in prior art U.S. Pat. No. 9,295,607 B2. FIG. 14 is reproduced from that disclosure and illustrates a device having two vacuum chambers 1504 and 1524 which are alternately activated as the device is dragged along the message-receiving surface by the user. This device is said to treat cellulite by breaking down sub-dermal (under the skin) fat cells, thus lessening the amount of sub-dermal fat, tightening loose skin, tightening and firming body surface, and reducing wrinkles in the skin. The skin is represented by label 1516 and the sub-dermal fat is represented by label 1520 in the diagram.

As the device in FIG. 14 is traversed along the surface of the skin by the user in the direction of arrow 1552, vacuum 1570 is applied to a first vacuum chamber 1524 which creates a skin fold as indicated by the bulge 1528. Simultaneously, positive air pressure is pumped into chamber 1504, as indicated by arrow 1560, forcing the previously formed skin roll 1518 out of the adjacent vacuum chamber 1504 to flatten the skin roll as indicated by arrow 1560. Considering what is experienced by a single fascial region along the tissue 1516, it experiences a cycle of raised protrusion (compression) and then flattening as the device passes by. This device is expensive to manufacture as it requires a vacuum pump to generate vacuum, a compressor to generate the positive air pressure, umbilical tubes, a series of coordinating solenoid valves and an associated remotely located electronic controller. Additionally, the device is incapable of producing percussive massage forces on the fascia in a downward direction.

Prior art U.S. Pat. No. 8,348,866 B2 discloses another device which is designed to induce a rolling skin fold upon the fascia surface. An excerpt from the '866 disclosure is shown herein as FIG. 15 where the rolling skin fold 31 is shown being induced between two sets of rolling elements 20 which each consist of a cluster of rollers 26. Two motors 40 are used to drive each of the rolling elements 126, with each motor being connected to its respective rolling element cluster by a belt. The disclosure explains that the rollers 26 are assisted by a “low vacuum level” to induce the rolling skin fold, where the vacuum is produced by an external vacuum pump. The negative pressure is symbolically represented by the undulated arrows 166 in the diagram. The '866 disclosure explains;
The invention relates in particular to the devices that make it possible to perform a massage of “rolling” type, that is, a massage that is used to treat the connective tissue of cutaneous areas and which involves exerting on a subject a continuous action during which a localized pinching of the skin and also a progressive displacement of the pinched area of skin must both be performed simultaneously, so as to provoke a “rolling” of the skin while exerting a pressure.
Conventionally, the “rolling” massages are performed by hand, which ultimately tires the masseur. In addition, the massage treatments performed in this way are not very uniform, since they depend on the level of the stresses exerted by the masseur, and on the state of tiredness of the latter. ('866 1:8-20)

In general, the percussive devices of the prior art cannot produce skin rolling and kneading action and the rolling motion devices cannot produce percussive action. None of the prior art devices referenced above provide the simultaneous application of Myofascial Release, Tapotement and Petrissage when the device is held steady at a position which is targeting treatment upon one specific fascia region. The simple instrument being described herein can accomplish these multiple actions upon the fascia surface without the need for vacuum pumps, umbilical attachments, multiple rollers, multiple motors or complicated mechanisms, thus providing a handheld, self-powered instrument which is especially economical to manufacture.

### SUMMARY OF THE EMBODIMENTS

The unique massage device being disclosed herein is designed to provide massage by collectively automating the three types of massage techniques which are normally utilized by massage therapists, including Myofascial Release, Tapotement (percussive massage) and Petrissage (skin rolling). These three massage techniques have been described in the prior art to treat cellulite (decompose fat cells), increase blood flow, decrease muscle stiffness, repair muscle tissue, reduce joint inflammation, for pain relief, and for increasing the flexibility of the fascial layers.

The Tiple Action Massage Gun being described herein combines the three common massage techniques to produce motor-driven “triple action” massage motion with the simplicity of a single massage roller and a single motor. The instrument comprises a handheld, portable massage device with a self-standing roller-supported configuration. The percussive massage head comprises a massage roller which reciprocates along a circular arc while inducing massage forces in directions along the surface of the fascia and also in directions perpendicular to the fascia surface, such that the device simultaneously combines the advantages of Myofascial Release, Tapotement (percussive massage) and Petrissage (skin rolling).

The device is simple, compact and relatively easy to manufacture in comparison to the prior art massage devices that require complex mechanical linkages, multiple rollers, multiple motors, umbilical attachments and/or vacuum chambers. The handheld device is completely portable and light weight, being powered by a small DC motor which receives its power from onboard rechargeable batteries and cooperates with onboard activation control. Treatments with this device do not require skin lubricants and can be made by the user in their own home or in the gym using one hand without reliance upon specialized skills or a massage therapist. The configuration and operation of the device will be better understood from the illustrated figures and descriptions that follow.

### BRIEF DESCRIPTION OF THE DRAWINGS

FIG. 1 is an illustration of the hand movement utilized by a massage therapist while implementing the Myofascial Release technique.

FIG. 2 is an illustration of a prior art device which is utilized to implement the Myofascial Release technique.

FIG. 3 is an illustration of the operation of the massage device described in FIG. 2.

FIG. 4 is a side elevation view of another prior art massage device which is utilized to implement the Myofascial Release technique.

FIG. 5 is an illustration of a hand movement utilized by a massage therapist while implementing the Tapotement (percussive massage) technique.

FIG. 6 is an illustration of a prior art percussive massage gun which is utilized to implement percussive massage.

FIG. 7 is a view of another prior art massage device that incorporates two handles to steady the massage gun upon a target fascia region while applying percussive massage.

FIG. 8 is an illustration of an exemplary application of the prior art massage device of FIG. 7.

FIG. 9 is an isometric view of another prior art massage device that is utilized for stabilizing a percussive massage gun upon a target fascia region while applying percussive massage.

FIG. 10 is an isometric view showing an exemplary application of the massage gun of FIG. 9.

FIG. 11 is an illustration of the hand movement utilized by a massage therapist while implementing the Petrissage (skin rolling) technique.

FIG. 12 is a diagram from a prior art patent that describes a device that is utilized for automating the Petrissage (skin rolling) technique.

FIG. 13 is a section view from a prior art patent disclosure that teaches another device for automating the Petrissage (skin rolling) technique.

FIG. 14 is a section view from another prior art patent disclosure that teaches a device for automating the Petrissage (skin rolling) technique.

FIG. 15 is a section view from another prior art patent disclosure that teaches a device for automating the Petrissage (skin rolling) technique.

FIG. 16 is a perspective view of an embodiment of the Triple Action Massage Gun being described herein.

FIG. 17 is an alternate perspective view of the device shown in FIG. 16.

FIG. 18 is a side elevation view of the device illustrated in FIG. 16 showing its arcuate massage head path.

FIG. 19 is a cut away view of the massage device of FIG. 16 showing the internal bellcrank drive mechanism.

FIG. 20A to FIG. 20C are various detailed views of the internal bellcrank drive mechanism illustrated in FIG. 19.

FIG. 21A, 21B and 21C illustrate the progressive sequence of massage head movements that create a compressive bulge (skin roll) upon a fleshy fascia region.

FIG. 22A and 22B illustrate the massage head motion of the device in FIG. 16 which includes percussive movement of the massage head in a direction perpendicular to the fascia surface.

FIG. 22C further explains the movement of the massage head perpendicular to the fascia surface as shown in FIG. 22A and FIG. 22B.

FIG. 23 is an isometric view of an alternate embodiment when adopting grooves upon the roller surface for fascia stimulation.

FIG. 24 is an isometric view of an alternate embodiment when adopting pyramidal projections upon the roller surface for fascia stimulation.

FIG. 25 is an isometric view of an alternate embodiment of the massage gun in FIG. 24 wherein the massage roller is prevented from freely rotating upon its axle.

FIG. 26 is an isometric view of an alternate embodiment of the bellcrank shown in FIG. 20C.

FIG. 27A is an isometric view of an alternate embodiment of the massage gun shown in FIG. 23.

FIG. 27B is an alternate isometric view of the massage gun shown in FIG. 27A.

FIG. 28A is an isometric view of an alternate embodiment of the massage gun shown in FIG. 23.

FIG. 28B is an isolated view of the detachable focusing rest shown in FIG. 28A.

FIG. 29A is an isometric view of an alternate embodiment of the massage gun shown in FIG. 28A.

FIG. 29B is an alternate isometric view of the massage gun shown in FIG. 29A.

FIG. 30 is a cut away view of an alternate embodiment that is a variant of the embodiment of FIG. 19.

FIG. 30A is an isolated view of the bellcrank configuration shown in FIG. 30.

FIG. 31 is an isometric view of the massage gun shown in FIG. 30.

FIG. 32A and FIG. 32B illustrate progressive steps of creating a skin roll utilizing the massage gun configuration of FIG. 30.

FIG. 33 is an isometric view of an alternate embodiment of the massage gun shown in FIG. 30.

FIG. 34 is an isometric view of another alternate embodiment of the massage gun shown in FIG. 30.

FIG. 35A is an alternate embodiment of the massage gun of FIG. 30 having a different bellcrank driving mechanism.

FIG. 35B is an alternate view of FIG. 35A showing the massage head moved to a different position.

FIG. 35C is an isolated view of the bellcrank driving mechanism shown in FIG. 35A.

FIG. 35D is an alternate view of the massage gun in FIG. 35A which explains the massage head movement that is perpendicular to the fascia surface.

FIG. 36A is an isometric view of an alternate massage gun embodiment.

FIG. 36B is a partial section view of the embodiment of FIG. 36A.

FIG. 36C is a partially exploded isometric view of the embodiment of FIG. 36A.

FIG. 37A is an isometric view of an alternate massage gun embodiment.

FIG. 37B is a partial section view of the embodiment of FIG. 37A.

FIG. 37C is an isolated view of the bellcrank mechanism of FIG. 37B.

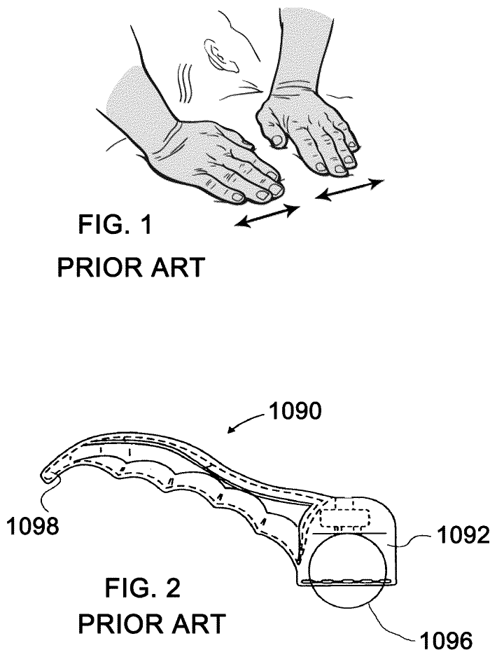

### DETAILED DESCRIPTION

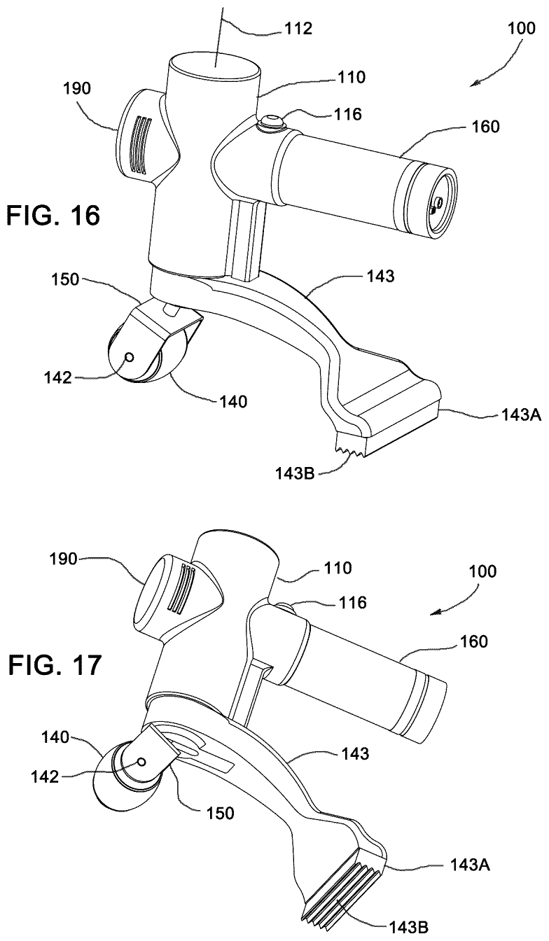

FIG. 16 illustrates an isometric view of the massage device being described as the preferred embodiment of the invention herein. The device 100 comprises a main body 110 having a series of appendages serving the functions of supporting the device and housing the functional components. The device is supported in a self-standing orientation while resting upon a suspension comprising of an oscillating percussive massage head 140 and a non-oscillating gripping surface 143B of a focusing rest 143 which are arranged in a tripod-like support configuration. The device comprises a single massage head for oscillating upon the surface of a first fascia region and a non-oscillating gripping surface for anchoring the massage gun upon a fascia surface at a second fascia region while the focusing rest is fixedly held against the fascia surface of the second fascia region.

The spacing amongst the focusing rest gripping surface 143B and the massage head 140 is proportioned to provide a self-standing suspension which maintains the axis 112 of the main body substantially perpendicular to the fascia surface absent a grasp of the user.

The term “focusing rest” was explained in copending patent application US 2022/0354735A. The term describes an appendage that allows a massage gun to be stabilized by resting a non-oscillating surface upon the fascia surface of one fascia region while focusing the reciprocating portion of a massage gun upon a particular muscle of another fascia region.

The focusing rest 143 is an injection molded component that is adjoined to the main body 110 at its proximal end and possesses an elastically deformable anchoring cushion 143A adjoined at its distal end. The anchoring cushion 143A is composed of soft elastomeric material such as rubber or urethane and has an axis that is perpendicular to the handle portion 160. A motor-driven bellcrank mechanism for oscillating the massage head resides within a cavity of the main body 110. The massage head comprises a percussive roller 140 which is attached to the distal end of a motor-driven bellcrank 150 which orbitally reciprocates within the cylindrical housing 110 while inducing the roller 140 to reciprocate along a circular arc. Roller 140 freely rotates upon the axis second axle 142 which is attached to a distal end of the bellcrank 150, the roller 140 defining a percussive massage roller which creates percussive contact upon the fascia surface without imposing frictional drag. The anchoring cushion 143A possesses a gripping surface 143B for anchoring the main body in place while maintaining non-oscillating contact with the fascia surface. FIG. 17 is an alternate isometric view which illustrates the configuration of the focusing rest 143 and the anchoring cushion 143A.

Referring to FIG. 16, the main body 110 has an axis 112 oriented perpendicular to the surface upon which the anchoring cushion 143B and roller 140 rest. A cylindrical projection 190 projects perpendicular to axis 112 and has the function of housing the motor which reciprocates a bellcrank 150 upon which roller 140 is adjoined. Another cylindrical projection 160 extends oppositely to the motor housing 190 and has the function of providing a single handle which is graspable by the user for operating the percussive massage gun with one hand. In some embodiments the handle 160 contains a cavity which houses removeable and/or rechargeable batteries for powering the device motor. In other embodiments, the handle 160 is removeable and contains a battery pack capable of remote charging. The device motor is powered on and off by the pushbutton 112 which is accessible to the user's thumb while grasping the handle 160.

FIG. 18 illustrates the path of the roller 140 and its extreme positions along the arc which it follows. Roller 140A indicates the extreme position of the massage roller after CW motion of the bellcrank 150 while 140B indicates the extreme position after CCW rotation of the bellcrank 150. Arc 146 indicates the periphery of the massage roller as it follows an arcuate path that is tangent to the fascia surface.

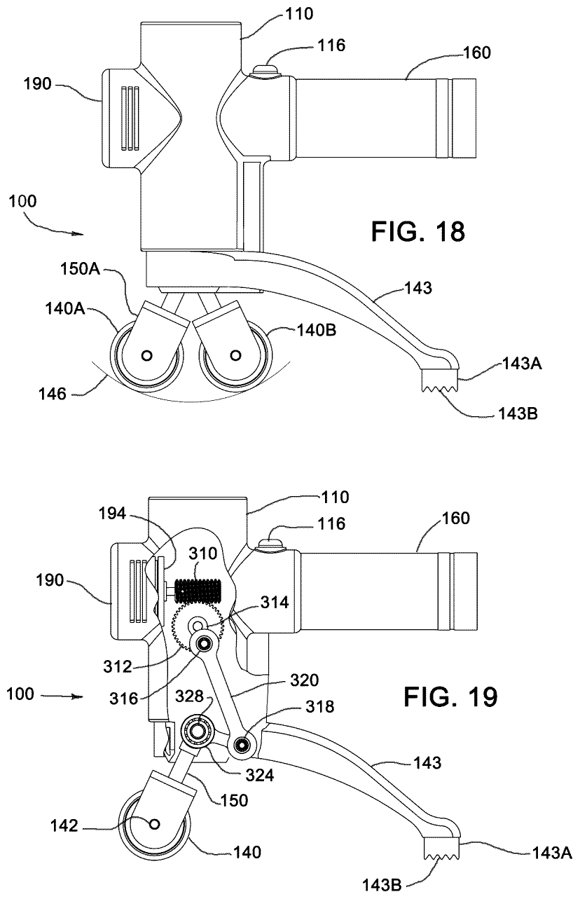

The bellcrank drive mechanism is especially simple when compared to many prior art massage guns. FIG. 19 is a side elevation view of the device 100 with the main body 110 shown in cut away fashion to expose the bellcrank drive mechanism which resides within the main body 110. A single gear set is comprised of a worm screw 310 which is coupled to the shaft of the drive motor 194 and in mesh with the worm gear 312. The device utilizes the single gear set comprising the worm screw and worm gear to both rotate and translate the upper end of a drive link 320. An eccentric crank 314 is attached to the worm gear 312 and is rotationally driven by the worm drive.

The drive link 320 is rotationally attached by a ball bearing 316 to the eccentric 314 at a first distal end and rotationally attached to the bellcrank 150 at a second distal end of the drive link by another bearing 318. Bellcrank 150 rotates upon a first axle 328 as the drive link rotates upon the bearing 318. A second axle 142 is attached to the bellcrank and possesses an axis that is parallel with the first axle 328. Percussive roller 140 is attached to the second axle 142 and freely rotates about the axis of axle 142.

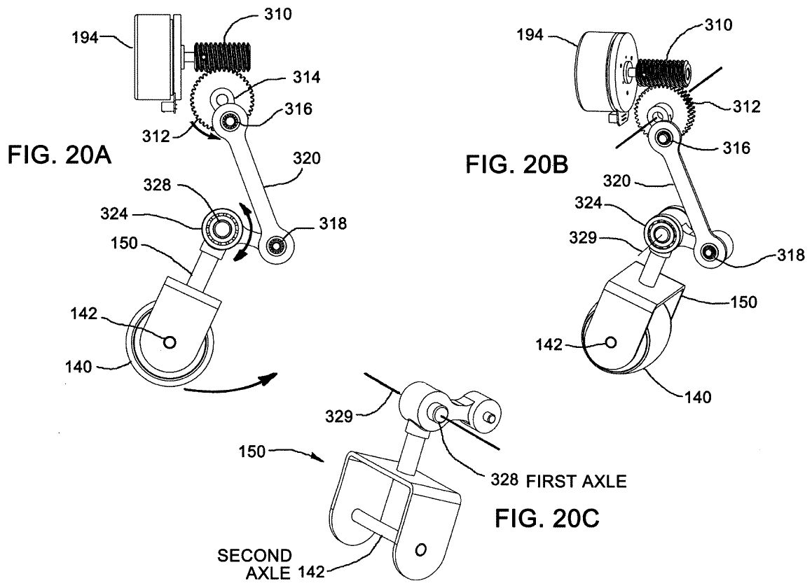

FIG. 20A and FIG. 20B illustrate views of the bellcrank drive mechanism when isolated from the device 100. FIG. 20A is a side elevation view and FIG. 20B is an analogous isometric view of the simple mechanism which utilizes only one gear set to implement triple action massage forces. A single gear set comprising a worm screw 310 and a worm gear 312 is driven by a DC motor 194 and rotates continuously when the device 100 is actuated. A connecting crank 314 is fixedly attached to the worm gear 312 and provides a journal for attaching the drive link 320 to the rotating worm gear 312. Ball bearing 316 is attached to the drive link 320 at its upper distal end and the bellcrank bearing 318 is rotatably attached to the drive link at its lower distal end.

The bellcrank 150 possesses two axles. The bellcrank rotates about the axis 329 of a first axle 328 which is contained within ball bearings 324. A second axle 142 is attached to the bellcrank and functions as the axis about which roller 140 freely rotates. Ball bearings 324 are fixedly attached to the main body 110 and function as journals upon which the first axle 328 rotates. Locations of the first axle 328 and the second axle 142 are more clearly shown in FIG. 20C, which illustrates an isometric view of the bellcrank 150 without the massage roller 140 or the driving mechanism. The single motor-driven gear set (310 and 312) is responsible for the triple action massage action by oscillating the percussive massage roller 140 while cooperating with the gripping surface 143B.

As the worm gear 312 rotates continuously CCW, the drive link 320 reciprocates and induces the bellcrank 150 to rotate about its axle 328 in a reciprocating arc. The periphery of the massage roller 140 follows the arcuate path 146 (see FIG. 18) which is tangent to the fascia surface.

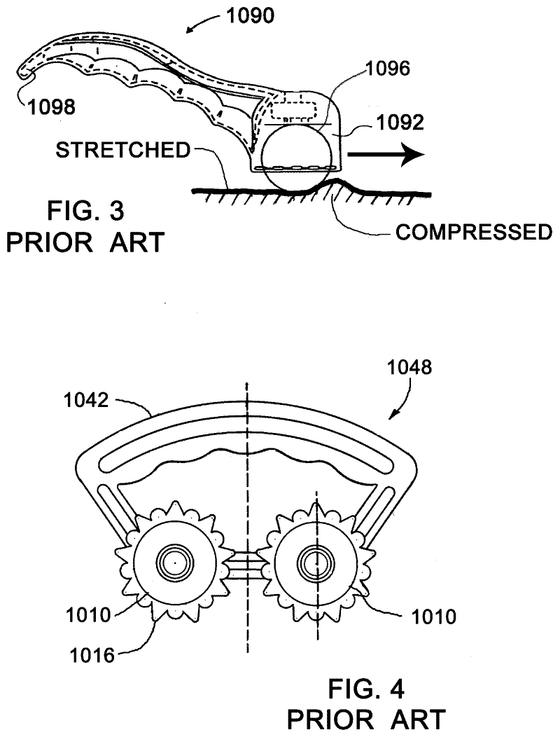

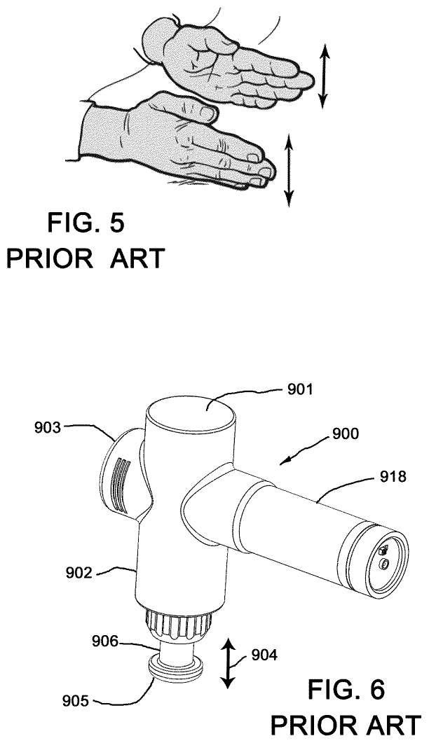

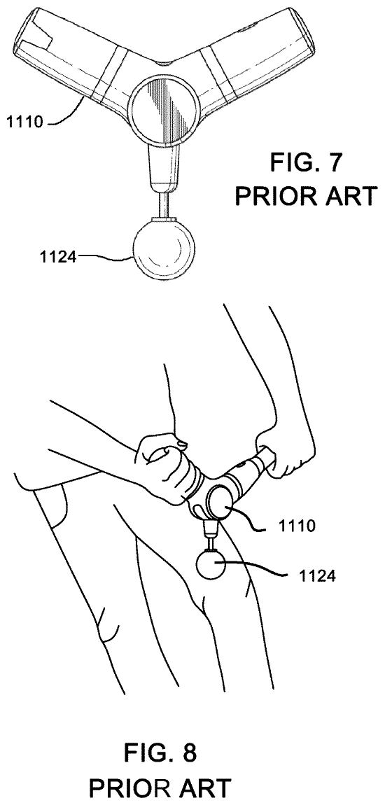

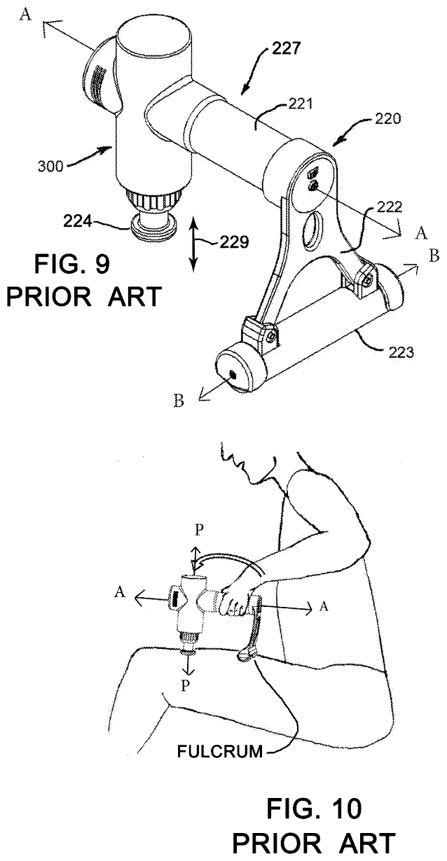

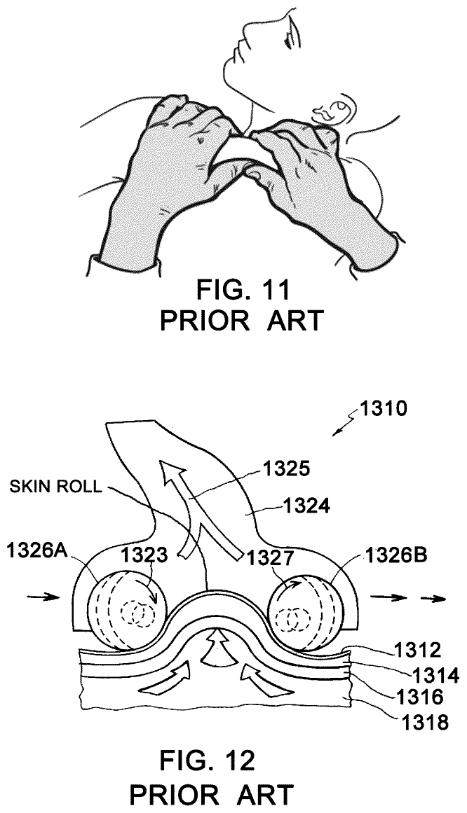

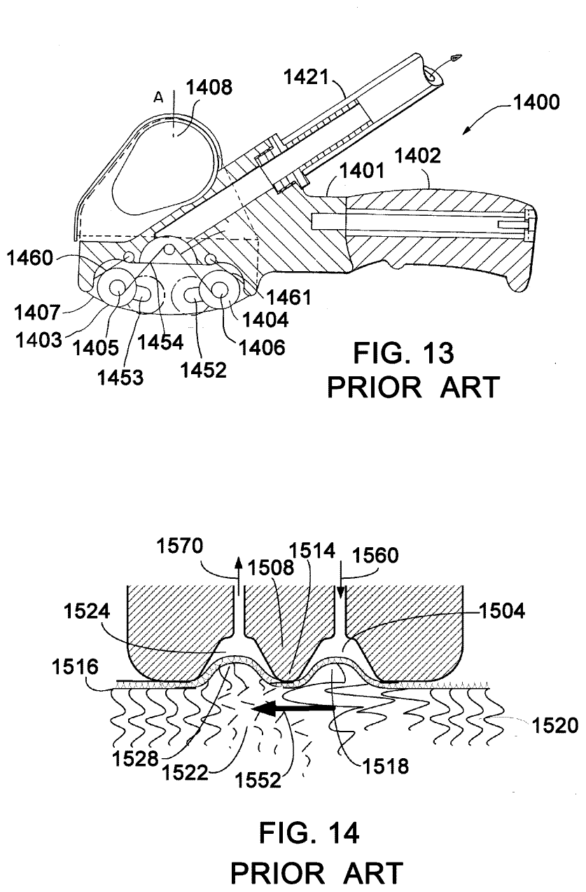

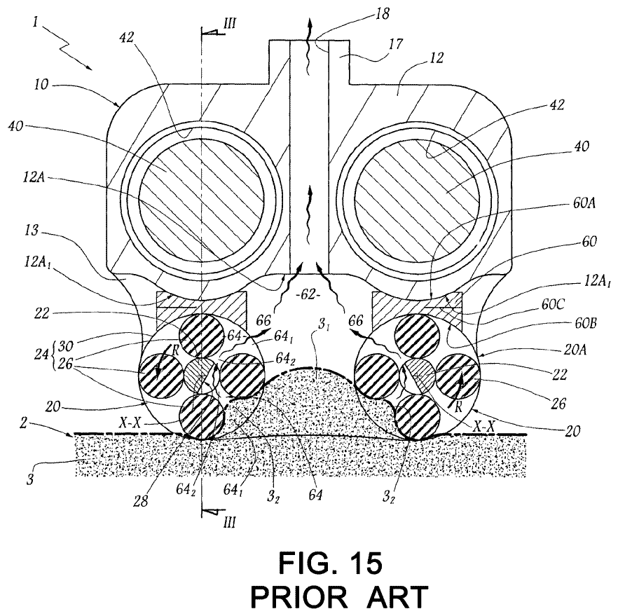

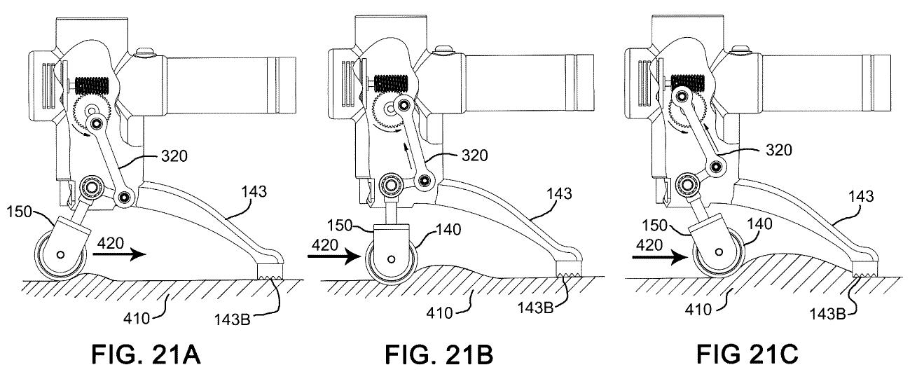

FIG. 21A, FIG. 21B and FIG. 21C illustrate the skin rolling action of the massage roller 140 as the roller progresses along the generalized plane of the fascia surface 410 and creates a skin roll as it approaches the gripping surface 143B. This Myofascial Release motion and Petrissage (skin rolling) action is illustrated by the directional arrows which indicate the relative motion of the massage roller 140 as it creates a travelling compressive wave which travels toward the gripping surface 143B of the focusing rest 143. Referring to FIG. 21A, the bellcrank 150 has begun rotating CW while moving the roller 140 in the direction of arrow 420. The user's pressure on the massage gun causes the roller 140 to create a travelling compressive wave along the fleshy surface of the fascia in the manner previously shown in FIG. 3. This wave is commonly called a skin roll in the art.

In FIG. 21B the skin roll has migrated in the direction of arrow 420 and has grown slightly larger while being pushed along the fleshy surface by roller 420. Referring to FIG. 21C, as the massage roller 140 continues to move toward the gripping surface 143B of the anchoring cushion 143A, the roller 140 induces a compressive wave that creates the rolling skin fold 430 in the direction of arrow 422. The gripping surface 143B provides resistance in the direction of the compressive wave and helps to force the fascia bulge in a direction vertical to the fascia surface. As the roller 140 reverses direction, the compressive wave is allowed to relax and thereafter stretches (flattens) as the massage roller moves in the direction opposite of arrow 420. The roller action lifts, compresses and stretches the fascia region upon which the device is focused. The free rotation of the roller 140 allows the compressive wave to be created without an uncomfortable frictional drag along the fascia surface.

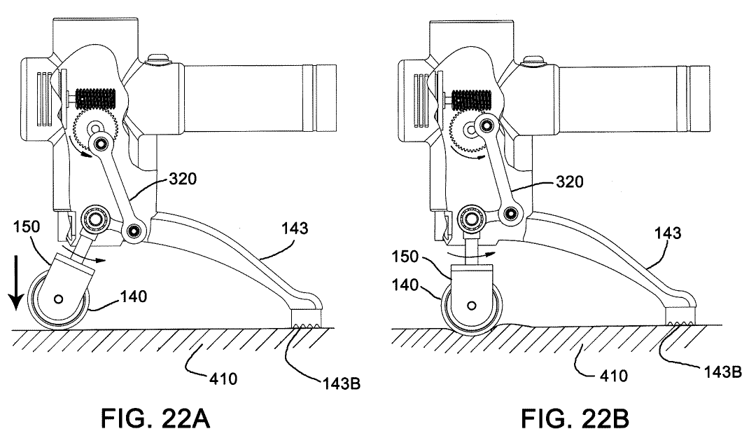

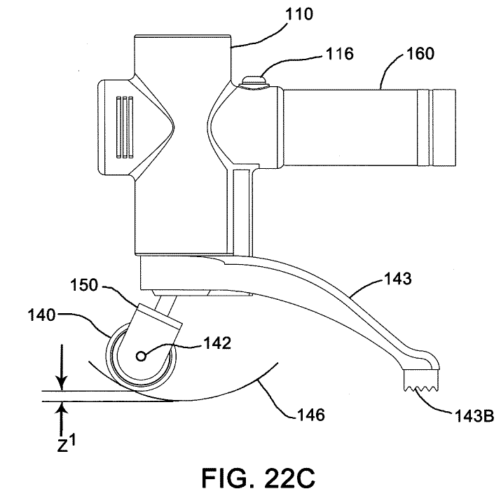

FIG. 22A and FIG. 22B demonstrate the range of motion of the massage roller 140 as it moves in the direction substantially perpendicular to the fascia surface. The roller 140 is moving downward in the direction of the arrow in FIG. 22A as it approaches the bottom of its arcuate path. The roller 140 has achieved the bottom of its arcuate path in FIG. 22B and will thereafter rise away from the fascia surface. FIG. 22C illustrates the vertical dimension Z¹ that represents the vertical component of the roller 140 movement as it traverses its arcuate path 146. This motion illustrates the Tapotement (percussive) action of the device 100 which is superimposed upon the Myofascial Release action and the skin rolling (Petrissage) action during each reciprocation cycle of the bellcrank 150. The percussive excursion Z¹ is directed perpendicular to the fascia surface.

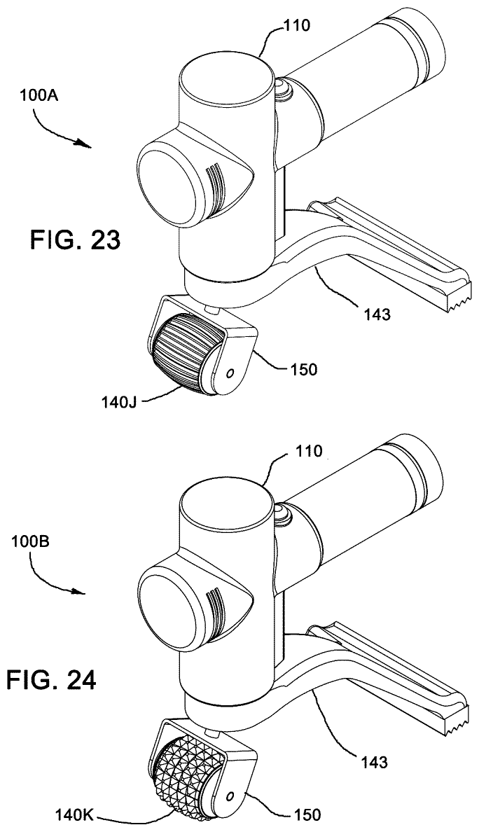

In other embodiments, the spherical surfaces of the roller 140 may be augmented with various fascia-stimulating surface projections. FIG. 23 illustrates an alternate embodiment identified as 100A which utilizes rollers with shallow grooves patterned upon the crowned surfaces of its roller 140J. FIG. 24 illustrates another alternate embodiment identified as 100C which utilizes small pyramidal projections patterned upon the crowned surfaces of its roller 140K.

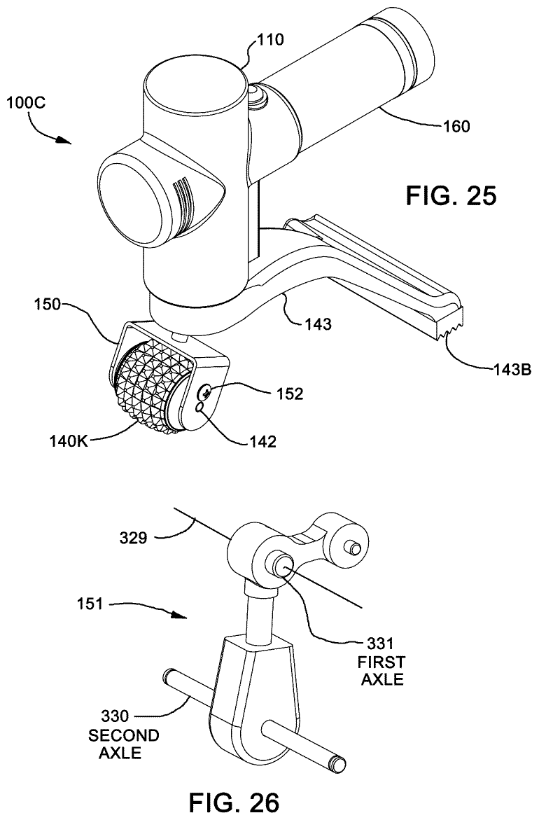

The skin rolling action may be made more aggressive by making the roller 140 non-rotatable upon its axle 142. One embodiment shown in FIG. 25 illustrate the disablement of the roller by pinning the roller to the bellcrank with a screw. In the embodiment identified as 100C, the roller 140J becomes affixed to the bellcrank 150 by the screw 152 and rotates about the axis of the first axle 328 rather than the second axle 142. The skin rolling action is made more aggressive in this configuration where the roller 140K is not freely rotatable upon the axis of the second axle 142.

In another alternate embodiment, the second axle of the bellcrank is configured to mount two freely rotatable massage rollers. FIG. 26 illustrates the configuration of the bellcrank 151 having a first axle 331 and a second axle 330 which is intended to provide a freely rotatable axis for mounting two rollers 140J. The second axle 330 rotates about the axis 329 of the first axle and provides an axis for a first massage roller and a second massage roller that are both freely rotatable upon the axis of the second axle 330.

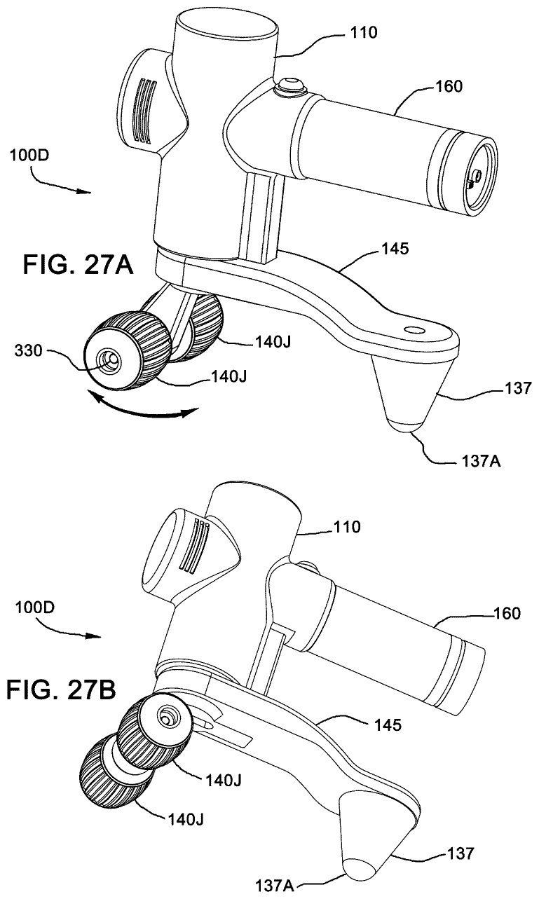

The bellcrank 151 is utilized in an alternate embodiment massage gun configuration as shown in FIG. 27A and FIG. 27B. This configuration, identified as massage gun 100D, uses two massage rollers 140J which are freely rotatable upon the axis of the second axle 330. Massage gun embodiment 100D also utilizes a gripping surface 137A having a curvilinear shape, where the term curvilinear shape includes gripping surfaces having cylindrical or spherical surfaces that can be concave or convex. FIG. 27A and FIG. 27B illustrate alternate isometric views of the massage gun having dual massage rollers and a spherical gripping surface 137A which extends from the conical cushion 137 which is adjoined to focusing rest 145. Cushion 137 is composed of a soft elastomeric material such as soft rubber or urethane which has a high friction coefficient and is easily deformable. The dual massage rollers 140J and the spherical gripping surface 137A cooperate to form the same skin rolling action as was illustrated in FIG. 21A, FIG. 21B and FIG. 21C. The spacing between the massage rollers and the spherical gripping surface of massage gun 100D also produces a massage gun configuration with a self-standing tripod-like suspension which maintains the axis of the main body substantially perpendicular to the fascia surface absent a grasp of the user.

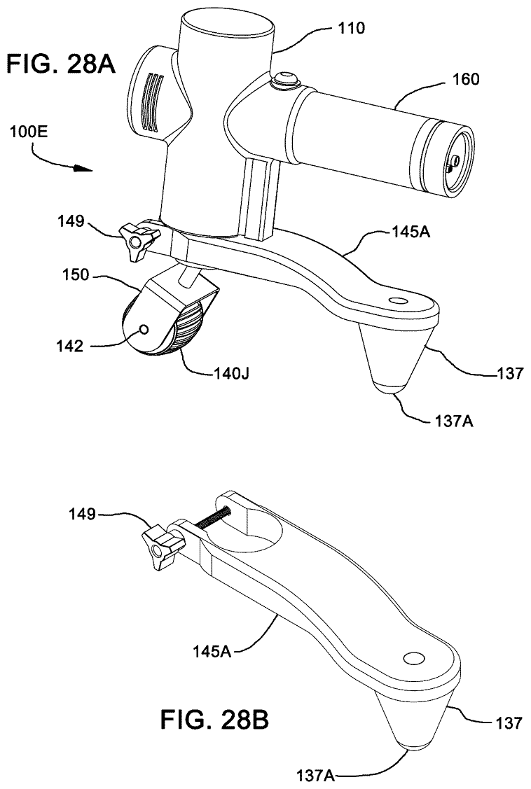

The gripping surface is detachable from the massage gun's main body in an alternate embodiment. FIG. 28A and FIG. 28B illustrate another embodiment where the focusing rest 145A and its gripping surface 137A are configured to be detachable from the massage gun 100E. In this embodiment a clamping mechanism is utilized to attach the focusing rest 145A. A clamp knob 149 is tightened to clamp the focusing rest 145A to the main body of the massage gun.

Other types of attachment means may be utilized including thumb screws, straps and twist lock devices. The detachable configuration allows the focusing rest to be sold as an optional accessory or to be packaged and stored in a compact configuration.

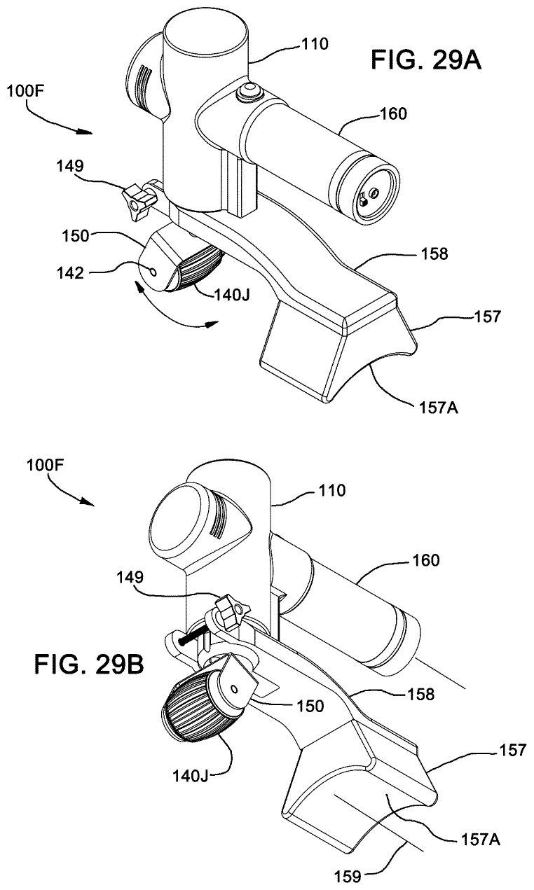

Another embodiment with a detachable gripping surface is shown in FIG. 29A and FIG. 29B. The focusing rest gripping surface 157A of massage gun 100F is curvilinear in shape, having a concave gripping surface that is intended to help align the direction of the arc of the reciprocating roller 140J with the axis of a limb such as an arm or a thigh. The axis 159 of the gripping surface 157A is parallel to the axis of the handle 160 and defines a cylindrical shape. The parallel axis feature helps to keep the massage head centered upon the axis of the limb. Cushion 157 is made of a soft conformable material with a high coefficient of friction such as a soft rubber or urethane. The detachable attribute of the focusing rest 158 in FIG. 29A allows this configuration to be optionally offered as an alternative accessory. The massage roller in this embodiment utilizes the same mechanism as shown in FIG. 19 to induce a fascia bulge as the roller 140J moves toward the gripping surface 157A (see FIG. 21A to FIG. 21C).

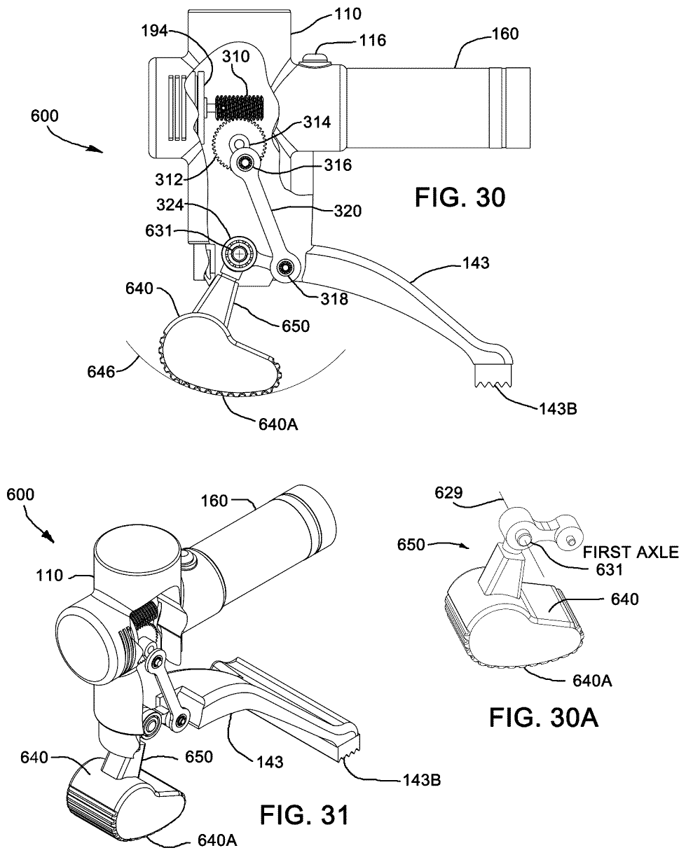

The massage roller may be further modified such that its periphery is concentric with the first axle rather than concentric with the second axle 142. FIG. 30 and FIG. 31 illustrate an alternate embodiment whereupon the massage head is a roller 640 which rotates about the axis 629 of the first axle 631 and is fixedly attached to the bellcrank 650. Referring to FIG. 30, the surface 640A of the roller 640 is concentric with the axis of the first axle 631 and that surface follows an arcuate path 646 that is tangent to the fascia surface as the bellcrank 650 reciprocates. The motorized bellcrank reciprocating mechanism of massage gun 600 is exactly the same as that shown in FIG. 19 with the exception of the distal end of the bellcrank. The configuration of bellcrank 650 is shown in FIG. 30A where the roller 640 is fixedly attached to the bellcrank and therefore rotates about the axis 629 of the first axle 631.

The alternative embodiment 600 utilizes the focusing rest 143 whose gripping surface 143B has an axis perpendicular to the massage gun handle 160. Other embodiments of gripping surfaces having curvilinear shapes such as cylindrical and spherical surfaces can be implemented that cooperate with the bellcrank 650 as further explained below.

Massage gun variant 600 is more aggressive in the skin rolling cellulite application because it imposes more contact area upon the fleshy fascia target region than do the configurations where the massage head roller freely rotates upon the second axle. The roller surface 640A remains tangent to the fascia surface while the bellcrank 650 oscillates. The noncircular shape of the roller 640 as shown in FIG. 30 increases the amount of surface area in contact with the fascia during skin rolling. The surface 640A additionally possesses stimulating projections to help grasp the skin roll in the first fascia region while the non-oscillating gripping surface 143B remains affixed to the second fascia region.

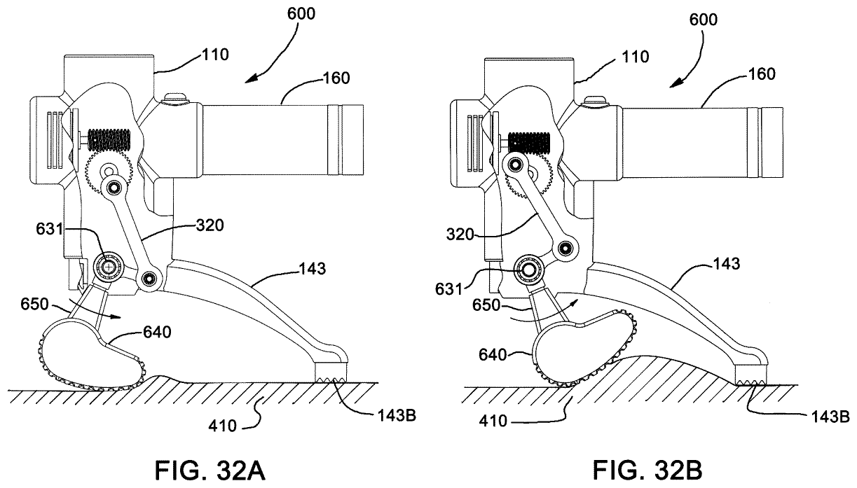

FIG. 32A and FIG. 32B illustrate the action of the massage roller 640 when targeting a first fascia region for treatment. While grasping the massage gun handle 160 with one hand, the user places the gripping surface upon a second fascia region to anchor the massage gun 600 upon the fascia. The user thereafter pivots the massage gun about the axis of the gripping surface until the massage head surface 640A is in contact with the fascia. The button 116 is engaged to empower the motor 194 to reciprocate the roller 640A along the fascia surface. Rotation of the bellcrank pushes the compressed fascia wave toward the gripping surface 143B while the bellcrank is rotating CCW such that the massage head creates a skin roll as it approaches the gripping surface. The skin roll becomes trapped by the gripping surface, causing the skin roll to bulge upward (exaggerated). As the roller 640 reverses its direction away from the gripping surface, the rolling fascia bulge becomes stretched as the compressive stress is relieved, and the fascia region experiences stretching which flattens the skin roll. The massage head is continuously reciprocated along the arcuate path by the motor upon the first fascia region while the non-oscillating gripping surface remains in a fixed position upon the second fascia region.

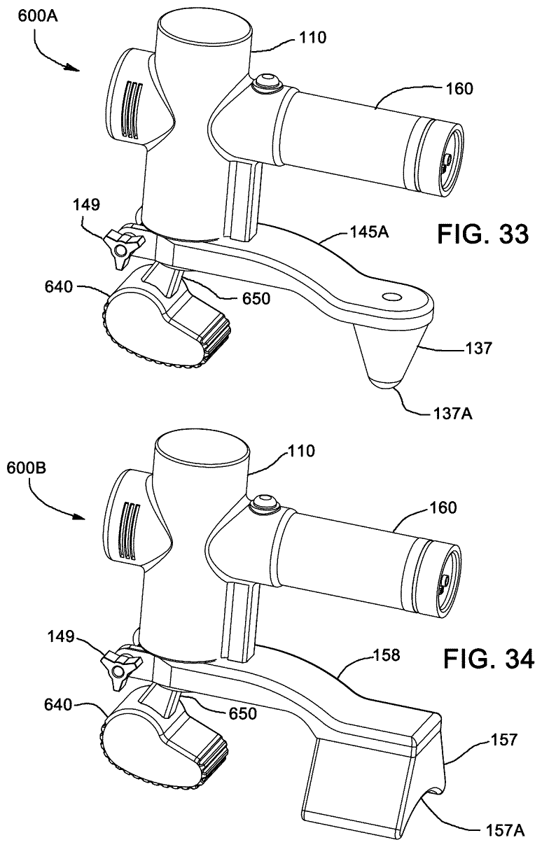

The massage gun 600 may be modified to utilize a detachable gripping surface in other embodiments. FIG. 33 and FIG. 34 illustrate embodiments having gripping surfaces which comprise curvilinear shapes. The massage gun embodiment 600A shown in FIG. 33 is modified to allow the focusing rest 145A to be detachable in the event that it is desirable to sell the focusing rest as an optional accessory for the massage gun 600A. Focusing rest 145A offers a spherical gripping surface 137A and was previously shown in FIG. 28A and 28B. In alternate embodiment, the spherical gripping surface 137A of the focusing rest 145A may be integrally adjoined to the main body 110.

A focusing rest 158 having a curvilinear shape comprising a concave cylindrical gripping surface 157A and an axis 159 parallel to the massage gun handle 160 could also be offered as an accessory as shown in the variant 600B in FIG. 34. Focusing rest attachment 158 is previously shown in FIG. 29A and 29B. The attachment 158 is sufficiently proportioned such that spacing amongst the massage head and the gripping surface is proportioned to provide a self-standing suspension which maintains the axis of the main body substantially perpendicular to the fascia surface absent a grasp of the user. The concave gripping surface 157A of focusing rest 158 may be integrally adjoined to the main body 110 in another embodiment.

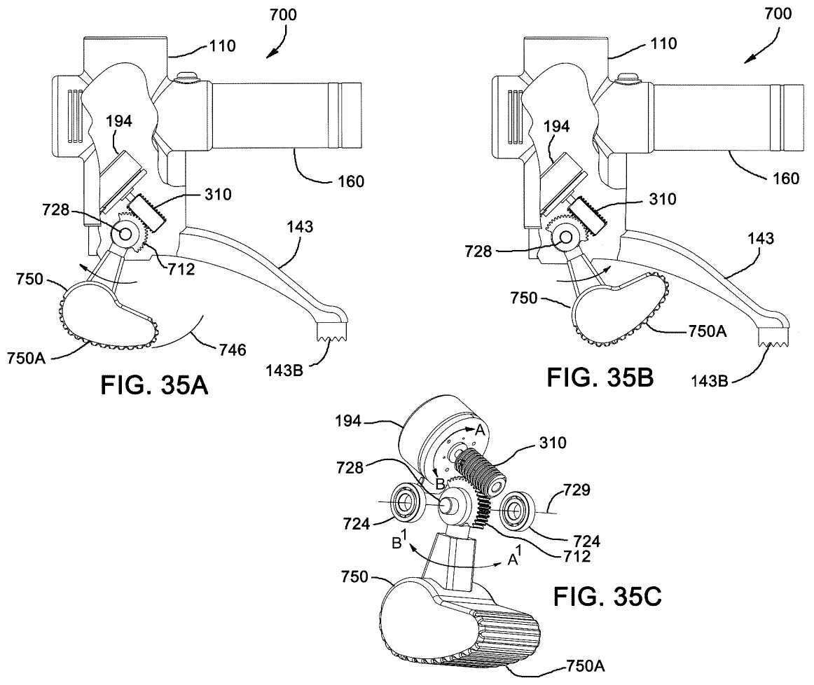

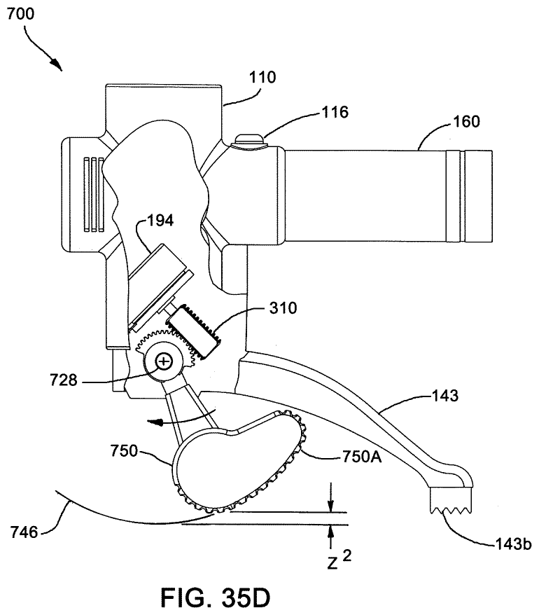

Alternate embodiments may utilize different bellcrank actuation mechanisms. The bellcrank 150 shown in FIG. 19 and the bellcrank 650 shown in FIG. 30 may be powered by mechanisms other than what is shown in those figures. For example, FIG. 35A shows an alternate embodiment massage gun 700 having a bellcrank 750 that is driven directly by the motor's worm screw 310. Rather than continuously rotating, the worm screw 310 reciprocates first CW and then CCW which reciprocates the bellcrank 750 such that the massage head periphery 750A follows an arcuate path 746 that is tangent to the fascia surface. Bellcrank 750 possesses a toothed portion 712 which meshes with the teeth of worm screw 310. The bellcrank 750 is directly driven by the worm screw 310 and the bellcrank excursion distance along the arc 746 is proportional to the rotational excursion of the motor 194. The bellcrank has rotated to it extreme CW direction in FIG. 35A and has achieved its extreme CCW position in FIG. 35B.

FIG. 35C shows an isolated view of the directly driven bellcrank 750 which oscillates about the first axle 728 having a rotation axis 729. Axle 728 is constrained to rotate within ball bearings 724 which are fixedly attached to the main body 110 of massage gun 700. As the motor rotates in the direction A, the bellcrank 750 rotates proportionally in the direction A¹. As the motor rotation reverses and thereafter rotates in the direction B, the bellcrank 750 rotates proportionally in the direction B¹. The embodiment of FIG. 35A has the advantage that the excursion length of the massage head along the reciprocating arc 746 may be made longer or shorter by adjusting the rotational excursion of the motor. In one embodiment, the massage gun may have an operator control for the purpose of adjusting the bellcrank excursion distance whereupon the operator control responds by adjusting the magnitude of the motor rotational excursions.

FIG. 35D demonstrates the range of motion of the massage roller surface 750A as it moves in the direction substantially perpendicular to the fascia surface. The roller surface 750A is moving downward in the direction of the arrow in the figure as it approaches the bottom of its arcuate path. The vertical dimension Z² represents the vertical component of the roller 750A movement as it traverses its arcuate path 746. This motion illustrates the Tapotement (percussive) action of the device 700 which is superimposed upon the Myofascial Release action and the skin rolling (Petrissage) action during each reciprocation cycle of the bellcrank 750. The percussive excursion Z² is directed perpendicular to the fascia surface.

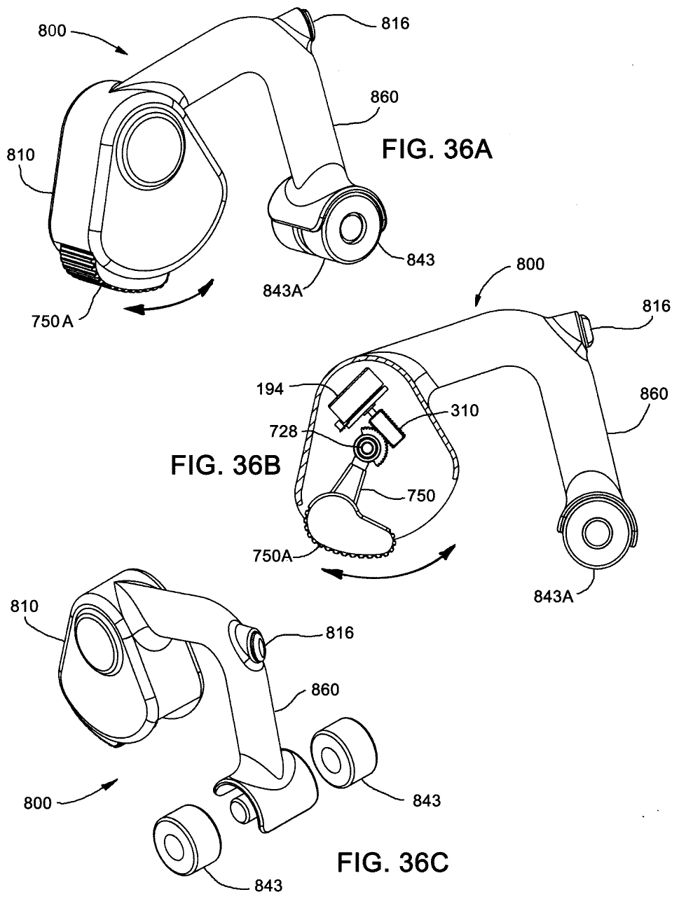

The massage gun 700 (FIG. 35A) may be reconfigured for more economic manufacture by combining functions. FIG. 36A, FIG. 36B and FIG. 36C illustrate an alternate embodiment massage gun 800 whereupon the focusing rest function is integrated into the handle such that the handle is grasped for one hand operation while simultaneously providing the focusing rest anchoring function. Referring to FIG. 36A, the handle 860 extends from the main body 810 to facilitate one hand operation by the user as the user's thumb actuates the switch 816 to empower the motor 194. The roller surface 750A reciprocates upon the fascia surface of the first fascia region as the curvilinear gripping surface 843A anchors the massage gun upon the second fascia region. The gripping surface is adjoined to the handle in this embodiment.

FIG. 36B is a partial section view through the main body 810 which illustrates the position of the directly driven bellcrank 750 which rotates upon first axle 728. The bellcrank driving mechanism shown in FIG. 36B is identical to the bellcrank driving mechanism shown in FIG. 35C.

Referring to FIG. 36C, the gripping surfaces 843A of massage gun embodiment 800 are adjoined to the handle portion 860. Two annular rings 843 are adjoined to the handle portion with epoxy such that they are non-rotatable while providing the gripping function upon the second fascia region. The cylindrical rings 843 provide curvilinear gripping surfaces that are made from soft elastomeric materials with high friction coefficients. Exemplary materials for the rings include soft rubber or soft urethane that have a high friction coefficient for anchoring the contact surface upon the second fascia region. Embodiment 800 utilizes the directly driven motorized bellcrank configuration to induce skin rolling action in the same way as illustrated in FIG. 32A and FIG. 32B.

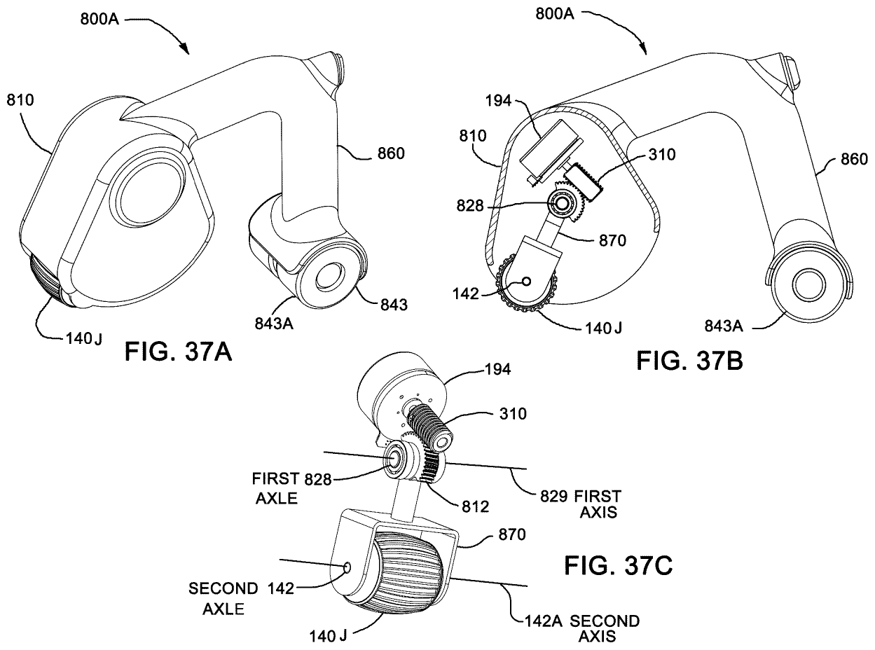

The integrated focusing rest configuration of massage gun 800 may be utilized in an embodiment which utilizes a massage head that includes the freely rotating roller as shown in FIG. 18. FIG. 37A illustrates an embodiment that combines the integrated handle 860 with the reciprocating massage head and freely rotating roller 140J which was previously illustrated in FIG. 23. FIG. 37B illustrates a partial section view of the massage gun 800A showing bellcrank 870 which rotates upon the axis 829 of the first axle 828 while the roller 140J rotates upon the axis 142A of the second axle 142. Referring to FIG. 37C, bellcrank 870 possesses a toothed portion 812 which meshes with worm screw 310. CW and CCW rotations of the motor cause the bellcrank 870 to rotate about a first axle 828 while the roller 140J rotates about a second axle 142. The periphery of the roller 140J reciprocates along an arcuate path. Massage gun 800A operates in the same manner as the massage gun 100 that is illustrated in FIG. 18 by sweeping roller 140 through a reciprocating arc 146 (FIG. 18), wherein the arc is tangent to the fascia surface. Roller 140J induces skin rolling action in the same way as illustrated in FIG. 21A, 21B and 21C.

The massage gun embodiment 800A shown in FIG. 37B has the advantage that the excursion length of the roller 140J along its arcuate path may be made adjusted longer or shorter by adjusting the rotational excursion of the motor. In one embodiment, the massage gun may have an operator control for the purpose of adjusting the length of the massage head excursion length along its arcuate path whereupon the operator control responds by variably adjusting the magnitude of the motor's CW and CCW rotational excursions.

One of ordinary skill, having designer's choice, may choose to utilize different forms of actuators and massage head configurations than those described herein. Other known forms of mechanisms for reciprocating the bellcrank may be substituted for those described herein. The device may be configured in other logical ways to provide a gripping surface on one fascia region while reciprocating a massage head upon a separate fascia region without deviating from the invention. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A handheld self-powered percussive massage gun for utilization by a user upon a fascia surface comprising:
a main body having an axis perpendicular to the fascia surface and defining a cavity;
a single handle portion extending therefrom, the single handle portion configured to be graspable by the user for operating the percussive massage gun with one hand;
a single massage head for oscillating upon the surface of a fascia at a first fascia region;
a non-oscillating gripping surface for anchoring the massage gun upon a fascia surface at a second fascia region;
a motor-driven mechanism residing within the main body cavity for oscillating the massage head;
the motor-driven mechanism having a single bellcrank which rotates upon a first axle;
the bellcrank having a distal end including a second axle for mounting the massage head therefrom;
wherein the massage head comprises a massage roller which freely rotates upon the axis of the second axle;
wherein the periphery of the massage roller reciprocates along an arcuate path that is tangent to the fascia surface;
wherein the massage head is continuously reciprocated along the arcuate path by the motor upon the first fascia region while the non-oscillating gripping surface remains in a fixed position upon the second fascia region; and
wherein the massage head creates a skin roll as it approaches the gripping surface and thereafter flattens the skin roll as it moves away from the gripping surface.

2. The massage gun of claim 1 wherein the bellcrank possesses a second axle at its distal end for mounting a massage head that is not freely rotatable upon the axis of the second axle.

3. The massage gun of claim 1 wherein the bellcrank possesses a second axle at its distal end for mounting a massage head comprising a first massage roller and a second massage roller that are both freely rotatable upon the axis of the second axle.

4. The massage gun of claim 1 wherein spacing amongst the massage head and the gripping surface is proportioned to provide a self-standing suspension which maintains the axis of the main body substantially perpendicular to the fascia surface absent a grasp of the user.

5. The massage gun of claim 1 wherein the massage head possesses stimulating projections.

6. The massage gun of claim 1 wherein the gripping surface has an axis that is perpendicular to the handle.

7. The massage gun of claim 1 wherein the gripping surface has an axis that is parallel to the handle.

8. The massage gun of claim 1 wherein the gripping surface comprises a curvilinear shape.

9. The massage gun of claim 1 wherein the gripping surface is detachable from the main body.

10. The massage gun of claim 1 wherein the gripping surface is adjoined to the handle.

11. The massage gun of claim 1 whereupon the excursion length of the arcuate path may be variably adjusted by controlling the rotational excursion of the motor.

12. A handheld self-powered percussive massage gun for utilization by a user upon a fascia surface comprising:
a main body having an axis perpendicular to the fascia surface and defining a cavity;
a single handle portion extending therefrom, the single handle portion configured to be graspable by the user for operating the percussive massage gun with one hand;
a single massage head for oscillating upon the surface of a fascia at a first fascia region;
a non-oscillating gripping surface for anchoring the massage gun upon a fascia surface at a second fascia region;
a motor-driven mechanism residing within the main body cavity for oscillating the massage head;
the motor-driven mechanism having a single bellcrank which rotates upon a first axle;
the massage head comprising a single roller which is rotatable upon the axis of the first axle and fixedly attached to the bellcrank;
wherein the distal end of the massage head reciprocates along an arcuate path that is tangent to the fascia surface;
wherein the massage head is continuously reciprocated along the arcuate path by the motor upon the first fascia region while the gripping surface remains in a fixed position upon the second fascia region; and
wherein the massage head creates a skin roll as it approaches the gripping surface and thereafter flattens the skin roll as it moves away from the gripping surface.

13. The massage gun of claim 12 wherein spacing amongst the massage head and the gripping surface is proportioned to provide a self-standing suspension which maintains the axis of the main body substantially perpendicular to the fascia surface absent a grasp of the user.

14. The massage gun of claim 12 wherein a massage head possesses stimulating projections.

15. The massage gun of claim 12 wherein the gripping surface has an axis that is perpendicular to the handle.

16. The massage gun of claim 12 wherein the gripping surface has an axis that is parallel to the handle.

17. The massage gun of claim 12 wherein the gripping surface comprises a curvilinear shape.

18. The massage gun of claim 12 wherein the gripping surface is detachable from the main body.

19. The massage gun of claim 12 wherein the gripping surface is adjoined to the handle.

20. The massage gun of claim 12 whereupon the excursion length of the arcuate path may be variably adjusted by controlling the rotational excursion of the motor.
